(19) United States
(12) Patent Application Publication
(10) Pub. No.: US 2026/0309737 A1
(43) Pub. Date: Oct. 8, 2026

(54) AUTOMATIC ANALYSIS APPARATUS AND AUTOMATIC ANALYSIS METHOD

(71) Applicant: CANON KABUSHIKI KAISHA, Tokyo (JP)

(72) Inventors: Tamaki HONDA, Ota (JP); Shozo HASHIMOTO, Nasushiobara (JP); Gaku UENO, Sakura (JP); Shohei KAWASHIMA, Nasushiobara (JP); Yoshihiro JIFUKU, Kariya (JP); Yuta SAITO, Nasushiobara (JP)

(73) Assignee: CANON KABUSHIKI KAISHA, Tokyo (JP)

(21) Appl. No.: 19/575,018

(22) Filed: Mar. 23, 2026

(30) Foreign Application Priority Data
Apr. 3, 2025 (JP) 2025-061635

(51) Int. Cl. G01N 35/10; G01N 35/00

(52) U.S. Cl. CPC G01N 35/1002; G01N 2035/00346; G01N 2035/1027

(57) ABSTRACT

An automatic analysis apparatus of an embodiment includes a reagent storage, an automatic reagent loading mechanism, a dispensing mechanism, and processing circuitry. The reagent storage stores a plurality of reagent bottles. The automatic reagent loading mechanism transports the reagent bottles from a reagent loading section to the reagent storage. The dispensing mechanism dispenses reagents contained in the reagent bottles stored in the reagent storage. The processing circuitry causes the dispensing mechanism to wait for dispensing until a standby time elapses from a reference time corresponding to when the reagent bottles are transported to the reagent storage and installed in the reagent storage by the automatic reagent loading mechanism.

### CROSS-REFERENCE TO RELATED APPLICATION

The present application claims priority based on Japanese Patent Application No. 2025-061635 filed Apr. 3, 2025, the content of which is incorporated herein by reference.

### FIELD

Embodiments disclosed in this specification and drawings relate to an automatic analysis apparatus and an automatic analysis method.

### BACKGROUND

Some reagents used in automatic analysis apparatuses are stored refrigerated or at room temperature, and some are prone to foaming. In clinical laboratories, to prevent deterioration of reagents contained in reagent bottles placed in a reagent storage of an automatic analysis apparatus, the reagent bottles are sometimes removed from the reagent storage and stored in a refrigerator after a test routine is completed, rather than being installed in the reagent storage. In this case, when the test routine is resumed, the reagent bottles are removed from the refrigerator and installed back in the reagent storage.

Some automatic analysis apparatuses are equipped with an automatic reagent loading mechanism that transports and installs reagent bottles from a reagent loading section to a reagent storage. In automatic analysis apparatuses equipped with an automatic reagent loading mechanism, a standby time may occur in the reagent loading section before reagent bottles are transported, to avoid a decrease in throughput.

In an automatic analysis apparatus, if reagent bottles that remain installed in the reagent storage are mixed with reagent bottles that have been stored in a refrigerator or are waiting in the reagent loading section in the reagent storage, there is a possibility that the temperature of the reagents used for testing will differ. In this case, for example, if the reagent temperature differs between the time of calibration and the time of sample measurement, this can cause a decrease in analytical accuracy.

Immediately after installing a reagent bottle in the reagent storage, liquid surface shaking or foaming of the reagent in the reagent bottle may occur. When liquid surface shaking or foaming of the reagent occurs, the amount of reagent extracted may become unstable. If the amount of reagent extracted becomes unstable, it may cause a decrease in analytical accuracy.

### BRIEF DESCRIPTION OF THE DRAWINGS

FIG. 1 is a block diagram showing an example of an automatic analysis apparatus 1 according to an embodiment.

FIG. 2 is a diagram showing an example of a configuration of an analysis mechanism shown in FIG. 1.

FIG. 3 is a flowchart showing an example of processing of the automatic analysis apparatus 1.

FIG. 4 is a diagram showing an example of a display 6 on which reagent information is displayed.

FIG. 5 is a diagram showing another example of the display 6 on which reagent information is displayed.

FIG. 6 is a diagram showing another example of the display 6 on which reagent information is displayed.

FIG. 7 is a diagram showing another example of the display 6 on which reagent information is displayed.

### DETAILED DESCRIPTION

An automatic analysis apparatus and an automatic analysis method according to an embodiment will now be described with reference to the drawings.

An automatic analysis apparatus according to an embodiment includes a reagent storage, an automatic reagent loading mechanism, a dispensing mechanism, and control circuitry. The reagent storage stores a plurality of reagent bottles. The automatic reagent loading mechanism transports the reagent bottles from a reagent loading section to the reagent storage. The dispensing mechanism dispenses reagents contained in the reagent bottles stored in the reagent storage. The control circuitry causes the dispensing mechanism to wait for dispensing until a standby time elapses from a reference time corresponding to when the automatic reagent loading mechanism transports the reagent bottles to the reagent storage and installs the same in the reagent storage.

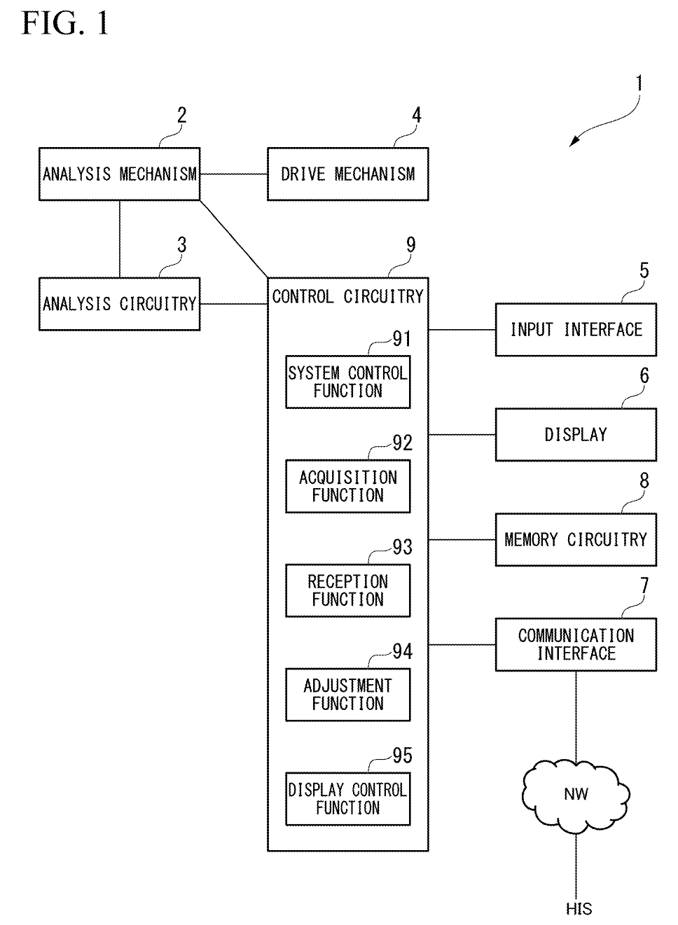

FIG. 1 is a block diagram showing an example of an automatic analysis apparatus 1 according to an embodiment. The automatic analysis apparatus 1 according to an embodiment includes, for example, an analysis mechanism 2, analysis circuitry 3, a drive mechanism 4, an input interface 5, a display 6, a communication interface 7, memory circuitry 8, and control circuitry 9.

The analysis mechanism 2 mixes a sample, such as a standard sample or a test sample, with reagents used for various test items set for the sample. Test items are set for samples for tests using reagents. The analysis mechanism 2 measures various properties of the mixture of the sample and reagents, such as absorbance, and generates standard data and test data associated with the measured absorbance. The analysis mechanism 2 measures the mixture of the sample and reagents and generates standard data and test data associated with, for example, an electrode potential.

The analysis circuitry 3 is a processor that generates calibration data, analytical data, etc. by analyzing the generated standard data and test data. The analysis circuitry 3 reads an operating program from the memory circuitry 8 and generates calibration data, analytical data, etc. in accordance with the read operating program. For example, the analysis circuitry 3 generates calibration data indicating a relationship between the standard data and a predetermined standard value with respect to the standard sample on the basis of the standard data.

The analysis circuitry 3 generates analytical data on the basis of the test data and calibration data for the test item corresponding to the test data. Analytical data includes data correlating concentration values with enzyme activity values and data recording the concentrations of desired ions in the sample in chronological order. The analysis circuitry 3 outputs the generated calibration data, analytical data, etc. to the control circuitry 9.

The drive mechanism 4 drives the analysis mechanism 2 under the control of the control circuitry 9. The drive mechanism 4 is realized, for example, by gears, a stepping motor, a belt conveyor, a lead screw, etc. The drive mechanism 4 rotates, for example, a reaction disk 104 which will be described below at a predetermined rotation angle. The predetermined rotation angle is, for example, the angle of rotation in one cycle which will be described below. The drive mechanism 4 rotates a reagent rack in the reagent storage 102, which will be described below.

The input interface 5 receives, for example, an input operation for setting analytical parameters and the like for each test item related to a sample for which measurement has been requested via a hospital network NW, performed by an operator. The input interface 5 is realized, for example, by a mouse, a keyboard, a touchpad to which instructions are input by touching an operation surface of the touchpad, or the like. The input interface 5 is connected to the control circuitry 9, converts instructions according to an input operation input by the operator into electrical signals, and outputs the electrical signals to the control circuitry 9.

In this specification, the input interface is not limited to one equipped with physical operation parts such as a mouse and a keyboard. For example, examples of input interfaces also include an electrical signal processing circuit that receives electrical signals corresponding to input operations from an external input device installed separately from the apparatus and outputs these electrical signals to the control circuitry.

The display 6 is connected to the control circuitry 9 and displays data representing a display target received from the control circuitry 9. This data includes data for a reagent storage window, a cleaning window, and a confirmation window, and the like. The display 6 also displays a standby time and a reference standby time, which will be described later, as part of reagent information.

For example, the display 6 may be a CRT display, an LCD display, an organic EL display, an LED display, a plasma display, or the like. The display 6 may also be equipped with a touch panel. In this case, the display 6 may also have the function of the input interface 5. The display 6 is an example of a display.

The communication interface 7 is connected, for example, to the hospital network NW. The communication interface 7 performs data communication with a hospital information system (HIS) via the hospital network NW. The communication interface 7 may also perform data communication with the HIS via a testing department system connected to the hospital network NW.

The memory circuitry 8 includes, for example, semiconductor memory elements such as a random access memory (RAM) and a flash memory, processor-readable recording media such as a hard disk and an optical disc, etc. The memory circuitry 8 does not necessarily have to be realized as a single storage device. The memory circuitry 8 may also be realized as a plurality of storage devices, for example.

The memory circuitry 8 stores test orders input by the operator, test orders received via the hospital network NW via the communication interface 7, or the like. Order information includes a sample ID (reagent name), test items required for the sample to be measured, and a measurement sequence for a test. The memory circuitry 8 stores various setting values for executing a series of operations in each unit of the automatic analysis apparatus 1 in one cycle. The memory circuitry 8 stores operating programs read by the control circuitry 9. The memory circuitry 8 is an example of a memory.

The memory circuitry 8 stores a reagent library with respect to a plurality of reagents. In the reagent library, reagent information and bottle information are associated with each other. Reagent information includes, for example, reagent names, barcode IDs, reagent types, numbers of remaining warning tests, a standby time, a number of stable days after start of use, etc. Bottle information includes information such as expiration dates, lot numbers, bottle numbers, etc.

The control circuitry 9 functions as the core of the automatic analysis apparatus 1. For example, the control circuitry 9 realizes such functions by a hardware processor executing a program stored in the memory circuitry 8. The control circuitry 9 outputs control signals for driving each unit of the analysis mechanism 2 to the drive mechanism 4. The control circuitry 9 may also include, for example, a memory storing at least some of the data stored in the memory circuitry 8. The control circuitry 9 is an example of a control unit.

The hardware processor refers to a circuit (circuitry) such as a central processing unit (CPU), a graphics processing unit (GPU), an application specific integrated circuit (ASIC), or a programmable logic device (e.g., simple programmable logic device (SPLD), complex programmable logic device (CPLD), or field programmable gate array (FPGA)). Instead of storing a program in the memory circuitry 8, the program may be directly embedded in the circuitry of the hardware processor. In this case, the hardware processor realizes the functions thereof by reading and executing the program embedded in the circuitry. The hardware processor is not limited to being configured as a single circuit, and may also be configured as a single hardware processor by combining a plurality of independent circuits to perform each function. A plurality of components may also be integrated into a single hardware processor to perform each function.

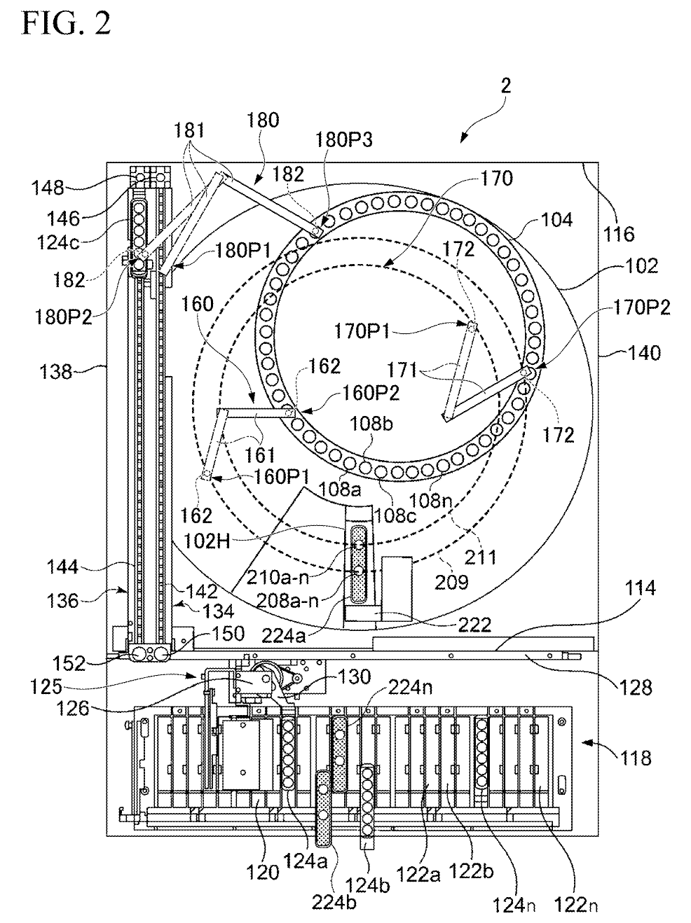

FIG. 2 shows an example of the configuration of the analysis mechanism shown in FIG. 1. In FIG. 2, a first side surface 114, a second side surface 116, a third side surface 138, and a fourth side surface 140 define the outer boundary of the analysis mechanism 2. The first side surface 114 and the second side surface 116 face each other, and the third side surface 138 and the fourth side surface 140 face each other.

The analysis mechanism 2 includes, for example, a reagent storage 102, a reaction disk 104, a reagent loading section 118, and an automatic reagent loading mechanism 125. The reagent storage 102 and the reaction disk 104 have different rotation axes as drive mechanisms. Both are rotation axes in the vertical direction.

The reaction disk 104 is disposed above the reagent storage 102 at a distance from the reagent storage 102. At least a part of the installation area of the reaction disk 104 overlaps with the installation area of the reagent storage 102 in a plan view. The reagent storage 102 and the reaction disk 104 may be disposed adjacent to each other, for example, on the same plane, without overlapping in a plan view.

The reagent storage 102 keeps a plurality of reagent bottles 224a to 224n refrigerated. The reagent bottles 224a to 224n contain reagents that react with specific components contained in standard samples or specific components contained in test samples. In the following description, when the plurality of reagent bottles 224a to 224n are not distinguished, they will be referred to as reagent bottles 224.

Since the reaction disk 104 is disposed above the reagent storage 102, the structure makes it difficult for the operator to directly access the reagent storage 102 regardless of whether the apparatus is operating or stopped. A structure that makes direct access difficult means that an operator cannot easily take reagent bottles in and out of the reagent storage 102 by hand. A reagent rack is rotatably provided in the reagent storage 102. The reagent rack holds the plurality of reagent bottles 224a to 224n arranged in an annular form. The reagent rack is rotated by the drive mechanism 4.

Each of the plurality of reagent bottles 224a to 224n contains at least one type of reagent. In the case of a reagent bottle containing two types of reagents, one container (outer annular array containers 208a to 208n which will be described below) contains a first reagent, and the other container (inner annular array containers 210a to 210n which will be described below) contains a second reagent that pairs with the first reagent. The following describes a case of a reagent bottle containing two types of reagents. Each of the plurality of reagent bottles 224a to 224n has a barcode affixed thereto, which is a numeric string associated with information such as the reagent name and bottle type.

The reagent storage 102 includes, for example, outer annular array containers 208a to 208n that move along a first annular path 209, and inner annular array containers 210a to 210n that move along a second annular path 211. The circles formed by the first annular path 209 and the second annular path 211 are concentric.

The reaction disk 104 holds a plurality of reaction tubes 108a to 108n in an annular arrangement. The reaction disk 104 is driven by the drive mechanism 4 to alternately rotate and stop at predetermined time intervals (hereinafter referred to as one cycle), for example, at intervals of 4.5 seconds. The plurality of reaction tubes 108a to 108n are made of, for example, glass. In the following description, a path along which the reaction tubes 108a to 108n move is referred to as a reaction tube annular path. When the plurality of reaction tubes 108a to 108n are not distinguished, they are referred to as reaction tubes 108.

The reagent loading section 118 is provided on the first side surface 114 of the analysis mechanism 2. The reagent loading section 118 has a loading rack 120 with a plurality of carriers 124a to 124n for transporting a plurality of sample containers and a plurality of slots 122a to 122n for receiving a plurality of reagent bottles 224a to 224n. In the following description, when the plurality of carriers 124a to 124n are not distinguished, they are referred to as carriers 124, and when the plurality of slots 122a to 122n are not distinguished, they are referred to as slots 122.

Either the carrier 124 or the reagent bottles 224 are inserted into the slot 122 in the loading rack 120. Although the carrier 124 holds six sample containers, the number of sample containers held by the carrier 124 is not limited thereto. A barcode with a numeric string associated with information such as a patient ID is affixed to the sample container.

The reagent loading section 118 is an area where a user inserts the carriers 124 and reagent bottles 224 into the automatic analysis apparatus 1 from outside the automatic analysis apparatus 1, and removes the same from the automatic analysis apparatus 1 after using the same in a test. The user may be, for example, a doctor, a laboratory technician, or the like who performs the test. The reagent bottles 224 containing reagents are stored, for example, in a refrigerator located outside the automatic analysis apparatus 1. When performing a test, the user removes the reagent bottles 224 from the refrigerator and inserts the same into the reagent loading section 118.

Reagent bottles 224 inserted into the reagent loading section 118 are transported by the automatic reagent loading mechanism 125 to a reagent bottle transport mechanism 222, and then installed on the reagent rack in the reagent storage 102 by the reagent bottle transport mechanism 222. The reagent bottles 224 containing reagents after use in a test in the reagent storage 102 are transported from the reagent storage 102 to the reagent loading section 118 by the automatic reagent loading mechanism 125. The user removes the transported reagent bottles 224 from the reagent loading section 118 and stores the same, for example, in a refrigerator.

The automatic reagent loading mechanism 125 includes, for example, a positioner 126 and an arm 130. The positioner 126 transports the carriers 124 and the reagent bottles 224. The arm 130 is attached to the positioner 126. The arm 130 engages with the carriers 124 and the reagent bottles 224.

The positioner 126 and the arm 130 remove either the carrier 124 or the reagent bottle 224 inserted in the slot 122. The positioner 126 and the arm 130 operate to transport the removed carrier 124 to either a first carrier shuttle 134 or a second carrier shuttle 136 and place the removed carrier 124 thereon. The positioner 126 and the arm 130 operate to transport the removed reagent bottle 224 to the reagent bottle transport mechanism 222 provided at an entrance/exit opening 102H of the reagent storage 102 and to cause the reagent bottle transport mechanism 222 to install the bottle 224 on the reagent rack in the reagent storage 102.

The positioner 126 has a barcode reader for reading the barcodes affixed to the reagent bottles 224 and each of the plurality of sample containers held by the carrier 124. For example, when the positioner 126 transports the carrier 124a, the barcode reader reads the barcodes affixed to the plurality of sample containers held by the carrier 124a.

For example, when the positioner 126 transports the reagent bottles 224a to 224n, the barcode reader reads the barcodes affixed to the reagent bottles 224. The barcode reader generates barcode information on the basis of the read barcodes and outputs the generated barcode information to the control circuitry 9.

Other identifiers may be affixed to the sample containers and the reagent bottles 224 instead of or in addition to barcodes. The identifiers affixed to the sample containers and the reagent bottles may be, for example, two-dimensional codes such as QR Codes (registered trademark), or IC tags using radio frequency identification (RFID). If RF tags are affixed, the positioner 126 may have a reader compatible with the IC tags.

The analysis mechanism 2 has the first carrier shuttle 134 and the second carrier shuttle 136 disposed near the second side surface 116. The arm 130 engages with the carrier 124. The carrier 124 is transferred to the first carrier shuttle 134 or the second carrier shuttle 136 by rotating the arm 130 and moving the positioner 126.

The first carrier shuttle 134 has a first track portion 142 extending from the first side surface 114 to the second side surface 116. The first track portion 142 has a track device formed of a belt, a chain, or the like, for example. The first carrier shuttle 134 has a first motor 146 for driving the first track portion 142 on the side of the second side surface 116. The first carrier shuttle 134 has a first sensor 150 on the side of the first side surface 114.

The second carrier shuttle 136 is disposed adjacent to the first carrier shuttle 134. The second carrier shuttle 136 has a second track portion 144 extending from the first side surface 114 to the second side surface 116. The second track portion 144 has, for example, a track device. The second carrier shuttle 136 has a second motor 148 for driving the second track portion 144 on the side of the second side surface 116. The second carrier shuttle 136 has a second sensor 152 on the side of the first side surface 114.

The first carrier shuttle 134 can transport the carrier 124 (here, carrier 124a) disposed on the first track portion 142 to any position. The second carrier shuttle 136 can transport the carrier 124 (here, carrier 124c) disposed on the second track portion 144 to any position.

The analysis mechanism 2 has the reagent bottle transport mechanism 222. The reagent bottle transport mechanism 222 takes in and out reagent bottles through the entrance/exit opening 102H provided in the reagent storage 102. The reagent bottle transport mechanism 222 has an arm (not shown). The arm of the reagent bottle transport mechanism 222 engages with a reagent bottle 224 (here, reagent bottle 224a) disposed in the entrance/exit opening 102H.

The reagent bottle 224 is removed from the entrance/exit opening 102H by the operation of the reagent bottle transport mechanism 222 and installed in the reagent storage 102. After testing, the reagent bottle 224 installed in the reagent storage 102 is removed from the entrance/exit opening 102H by the operation of the reagent bottle transport mechanism 222 and transported to the reagent loading section 118 by the automatic reagent loading mechanism 125.

The analysis mechanism 2 has a first pipetting mechanism 160, a second pipetting mechanism 170, and a third pipetting mechanism 180. The first pipetting mechanism 160 is, for example, provided inside the reagent storage 102 and outside the reaction disk 104. The second pipetting mechanism 170 is, for example, provided on the periphery of the reaction disk 104. The third pipetting mechanism 180 is, for example, provided outside the reagent storage 102. The locations at which the first pipetting mechanism 160, the second pipetting mechanism 170, and the third pipetting mechanism 180 are provided are not limited to the locations described above.

The first pipetting mechanism 160 has a first reagent dispensing arm 161. A vertically movable rotation shaft extending in the vertical direction is attached to one end of the first reagent dispensing arm 161. The first reagent dispensing arm 161 is movable up and down in the vertical direction and rotatable about the vertical axis by the drive mechanism 4. The first reagent dispensing arm 161 holds a first reagent dispensing probe 162 at the other end. The first pipetting mechanism 160 is an example of a dispensing mechanism.

The first reagent dispensing probe 162 rotates along a first arc-shaped rotation trajectory as the first reagent dispensing arm 161 rotates. A first reagent suction position 160P1 at which the first reagent dispensing probe 162 aspirates a first reagent from a reagent bottle (outer annular array container) is provided on the first rotation trajectory. The top surface of the first reagent suction position 160P1 in the reagent storage 102 is open. The first reagent suction position 160P1 corresponds to, for example, the intersection of the first rotation trajectory and the first annular path 209.

A first reagent discharge position 160P2 at which the first reagent aspirated by the first reagent dispensing probe 162 is discharged into a reaction vessel is provided on the first rotation trajectory. The first reagent discharge position 160P2 corresponds, for example, to the intersection of the first rotation trajectory and the reaction tube annular path. A washing position at which the first reagent dispensing probe 162 is washed may be provided at a position on the first rotation trajectory, different from the first reagent suction position 160P1 and the first reagent discharge position 160P2. A washing tank for washing the first reagent dispensing probe 162 may be provided at the washing position.

The first reagent dispensing probe 162 aspirates the first reagent from the outer annular array container located directly below the first reagent suction position 160P1 under the control of the control circuitry 9. The first reagent dispensing probe 162 discharges the aspirated first reagent into a reaction tube located directly below the first reagent discharge position 160P2 under the control of the control circuitry 9. The first pipetting mechanism 160 performs this series of aspirating and discharging operations (dispensing operation), for example, once per cycle.

The second pipetting mechanism 170 has a second reagent dispensing arm 171. A vertically movable rotation shaft extending in the vertical direction is attached to one end of the second reagent dispensing arm 171. The second reagent dispensing arm 171 is movable up and down in the vertical direction and rotatable about the vertical axis by the drive mechanism 4. The second reagent dispensing arm 171 holds a second reagent dispensing probe 172 at the other end. The second pipetting mechanism 170 is an example of a dispensing mechanism.

The second reagent dispensing probe 172 rotates along a second arc-shaped rotation trajectory as the second reagent dispensing arm 171 rotates. A second reagent suction position 170P1 at which the second reagent dispensing probe 172 aspirates a second reagent from a reagent bottle (inner annular array container) is provided on the second rotation trajectory. The top surface of the second reagent suction position 170P1 in the reagent storage 102 is open. The second reagent suction position 170P1 corresponds to, for example, the intersection of the second rotation trajectory and the second annular path 211.

A second reagent discharge position 170P2 at which the second reagent aspirated by the second reagent dispensing probe 172 is discharged into a reaction vessel is provided on the second rotation trajectory. The second reagent discharge position 170P2 corresponds, for example, to the intersection of the second rotation trajectory and the reaction tube annular path. A washing position at which the second reagent dispensing probe 172 is washed may be provided at a position on the second rotation trajectory, different from the second reagent suction position 170P1 and the second reagent discharge position 170P2. A washing tank for washing the second reagent dispensing probe 172 may be provided at the washing position.

The second reagent dispensing probe 172 aspirates the second reagent from the outer annular array container located directly below the second reagent suction position 170P1 under the control of the control circuitry 9. The second reagent dispensing probe 172 discharges the aspirated second reagent into a reaction tube located directly below the second reagent discharge position 170P2 under the control of the control circuitry 9. The second pipetting mechanism 170 performs this dispensing operation, for example, once per cycle.

The third pipetting mechanism 180 has a sample dispensing arm 181. A vertically movable rotation shaft extending in the vertical direction is attached to one end of the sample dispensing arm 181. The sample dispensing arm 181 is movable up and down in the vertical direction and rotatable about the vertical axis by the drive mechanism 4. The sample dispensing arm 181 holds a sample dispensing probe 182 at the other end. The third pipetting mechanism 180 is an example of a dispensing mechanism.

The sample dispensing probe 182 rotates along a third arc-shaped rotation trajectory as the sample dispensing arm 181 rotates. A first sample suction position 180P1 and a second sample suction position 180P2 at which the sample dispensing probe 182 aspirates a sample from a sample container are provided on the third rotation trajectory.

The first sample suction position 180P1 corresponds, for example, to the intersection of the third rotation trajectory and the first track portion 142. The second sample suction position 180P2 corresponds, for example, to the intersection of the third rotation trajectory and the second track portion 144. A sample discharge position 180P3 at which the sample aspirated by the sample dispensing probe 182 is discharged into a reaction vessel is provided on the third rotation trajectory. The sample discharge position 180P3 corresponds, for example, to the intersection of the third rotation trajectory and the reaction tube annular path.

A washing position at which the sample dispensing probe 182 is washed may be provided at a position on the third rotation trajectory, different from the first sample suction position 180P1, the second sample suction position 180P2, and the sample discharge position 180P3. A washing tank for washing the sample dispensing probe 182 may be provided at the washing position.

The sample dispensing probe 182 aspirates a sample from a sample container located directly below the first sample suction position 180P1 or from a sample container located directly below the second sample suction position 180P2 under the control of the control circuitry 9. The sample dispensing probe 182 discharges the aspirated sample into a reaction tube located directly below the sample discharge position 180P3 under the control of the control circuitry 9. The sample dispensing probe 182 and the third pipetting mechanism 180 perform this dispensing operation, for example, once per cycle.

The analysis mechanism 2 further includes an electrode unit, a photometric unit, a cleaning unit, and a stirring unit. The electrode unit measures an electrolyte concentration of a mixture of a sample and a reagent discharged into a reaction tube. The photometric unit optically measures a specific component in the mixture. The cleaning unit cleans the inside of the reaction tube after the electrode unit or photometric unit has finished measurement of the mixture. The stirring unit has a stirring bar, and uses the stirring bar to stir the sample, reagent, mixture, etc. contained in the reaction tube located directly below a stirring position on the reaction disk 104.

Next, the functions of the control circuitry 9 according to the embodiment will be described. The control circuitry 9 shown in FIG. 1 executes operating programs stored in the memory circuitry 8 to realize the functions corresponding to the programs. For example, the control circuitry 9 includes a system control function 91, an acquisition function 92, a reception function 93, an adjustment function 94, and a display control function 95.

Although a case in which the system control function 91, the acquisition function 92, the reception function 93, the adjustment function 94, and the display control function 95 are realized by a single processor is described in the embodiment, the present invention is not limited thereto. For example, the control circuitry may be configured by combining a plurality of independent processors, and the system control function 91, the acquisition function 92, the reception function 93, the adjustment function 94, and the display control function 95 may be realized by the respective processors executing operating programs.

The system control function 91 overall controls each component of the automatic analysis apparatus 1 on the basis of, for example, input information input via the input interface 5. The control circuitry 9 controls, for example, the rotation operations of the reagent rack in the reagent storage 102 and the reaction disk 104, the rotation operation and dispensing operation of the first reagent dispensing probe 162, the rotation operation and dispensing operation of the second reagent dispensing probe 172, the rotation operation and dispensing operation of the sample dispensing probe 182, and the like. The system control function 91 controls the transporting operations of the positioner 126, the first carrier shuttle 134, the second carrier shuttle 136, and the reagent bottle transport mechanism 222.

The system control function 91 causes the pipetting mechanisms 160, 170, and 180 to wait for dispensing until a standby time elapses from when the reagent bottle 224 is installed in the reagent storage 102 by the automatic reagent loading mechanism 125. The time at which the reagent bottle 224 has been installed in the reagent storage 102 corresponds to a reference time corresponding to the installation in the reagent storage 102. The reference time may be the time at which the reagent bottle 224 has been installed in the reagent storage 102, or an appropriate time based on the time at which the reagent bottle 224 has been installed in the reagent storage 102.

The acquisition function 92 acquires the standby time stored in the memory. The acquisition function 92 acquires barcode information transmitted by a barcode reader provided in the positioner 126 in the automatic reagent loading mechanism 125. The barcode information corresponds to the barcode affixed to the reagent bottle 224 placed in the reagent loading section 118.

The acquisition function 92 reads the reagent information corresponding to the acquired barcode information from the memory circuitry 8 and acquires the standby time contained in the read reagent information. The acquired standby time corresponds to the standby time for the reagent contained in the reagent bottle 224 inserted into the reagent loading section 118. The standby time is set, for example, on the basis of the type of reagent and the test item. The acquisition function 92 may use the acquired standby time as is, or may use the same as a reference standby time that serves as the basis for a standby time set by the reception function 93 or the adjustment function 94. The acquisition function 92 is an example of an acquisition unit. The “reagent type” that serves as the basis for setting the standby time is not particularly limited, and reagent types may be divided at any level of granularity. For example, the standby time may be set on the basis of each reagent from each manufacturer, or on the basis of a reagent prepared by the user. Furthermore, the standby time may be set on the basis of the lot number or batch number of the reagent, or may be set for each reagent bottle.

The reception function 93 receives input of a standby time. The reception function 93 receives, for example, designation information designating the standby time input through the input interface 5. The standby time acquired by the acquisition function 92 is displayed on the display 6, for example, by the display control function 95. The user operates the input interface 5 to adjust the standby time displayed on the display 6 as needed. The input interface 5 generates designation information corresponding to the operation and outputs the same to the control unit circuit. The reception function 93 is an example of a reception unit.

The adjustment function 94 adjusts the standby time on the basis of a cooling status of the reagent bottle 224. The adjustment function 94 acquires, for example, cooling status information regarding the cooling status of the reagent bottle 224 inserted into the reagent loading section 118. The cooling status information includes, for example, placement time information regarding the placement time of the reagent bottle 224 in the reagent loading section 118 and pre-loading storage location information regarding the storage location of the reagent bottle 224 before being loaded into the reagent loading section 118.

For example, if the placement time is long, the adjustment function 94 will increase the standby time accordingly since the temperature of the reagent bottle 224 will be closer to room temperature. For example, if the pre-loading storage location is a shelf for room-temperature storage, the adjustment function 94 will increase the standby time compared to a case in which the pre-loading storage location is a refrigerator for refrigerated storage. In another example, the adjustment function 94 may acquire temperature information of the pre-loading storage location as pre-loading storage location information and adjust the standby time on the basis of that temperature. The adjustment function 94 is an example of an adjustment unit.

The display control function 95 causes the display to display the standby time. For example, the display control function 95 causes the display 6 to display the standby time acquired by the acquisition function 92 and adjusted by the adjustment function 94. The display control function 95 causes the display 6 to display the standby time set for each reagent. The display control function 95 may cause the display 6 to display the standby time set for each test item. The display control function 95 causes the display 6 to display information other than the standby time, for example, reagent information. The display control function 95 is an example of a display control unit.

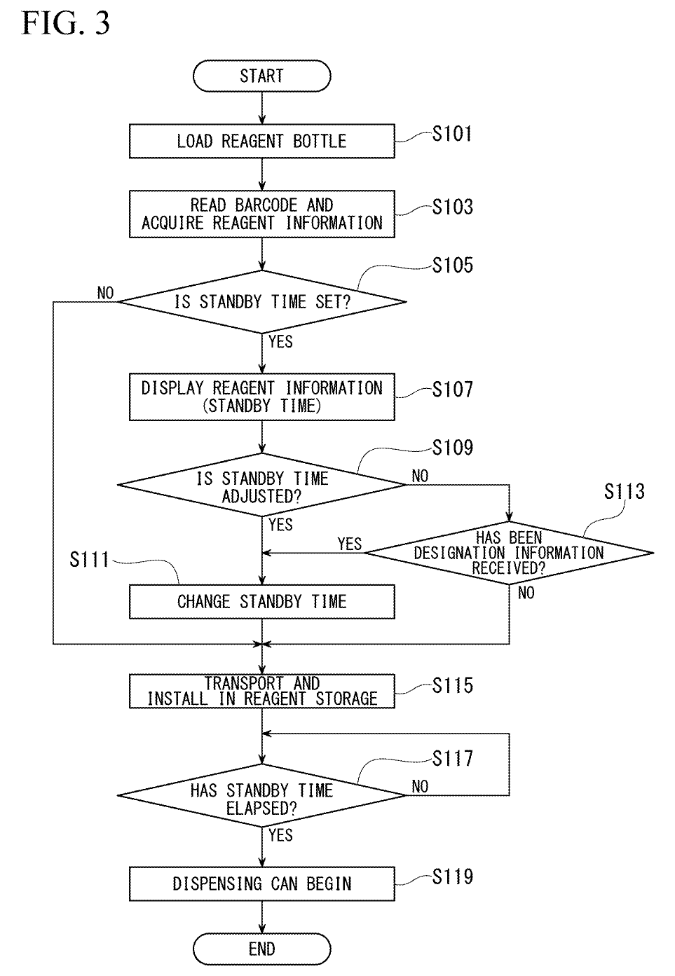

Next, processing of the automatic analysis apparatus 1 of the embodiment will be described. FIG. 3 is a flowchart showing an example of processing of the automatic analysis apparatus 1. The flowchart shown in FIG. 3 describes processing from when a reagent bottle is loaded into the automatic analysis apparatus 1 until dispensing of a sample and a reagent begins.

In the automatic analysis apparatus 1, first, a user loads a reagent bottle 224 containing a reagent to be used for testing into the reagent loading section 118 (step S101). Next, the barcode reader provided in the positioner 126 of the automatic reagent loading mechanism 125 reads the barcode information affixed to the reagent bottle 224, generates barcode information, and outputs the same to the control circuitry 9. The acquisition function 92 acquires the output barcode information and reads and acquires reagent information corresponding to the acquired barcode information from the memory circuitry 8 (step S103).

Next, the system control function 91 determines whether the reagent information corresponding to the barcode information acquired by the acquisition function 92 includes a standby time (is non-zero) (step S105). If the system control function 91 determines that there is no standby time, the system control function 91 proceeds to step S115. If the system control function 91 determines that there is a standby time, the display control function 95 causes the display 6 to display the reagent information acquired by the acquisition function 92 (step S107).

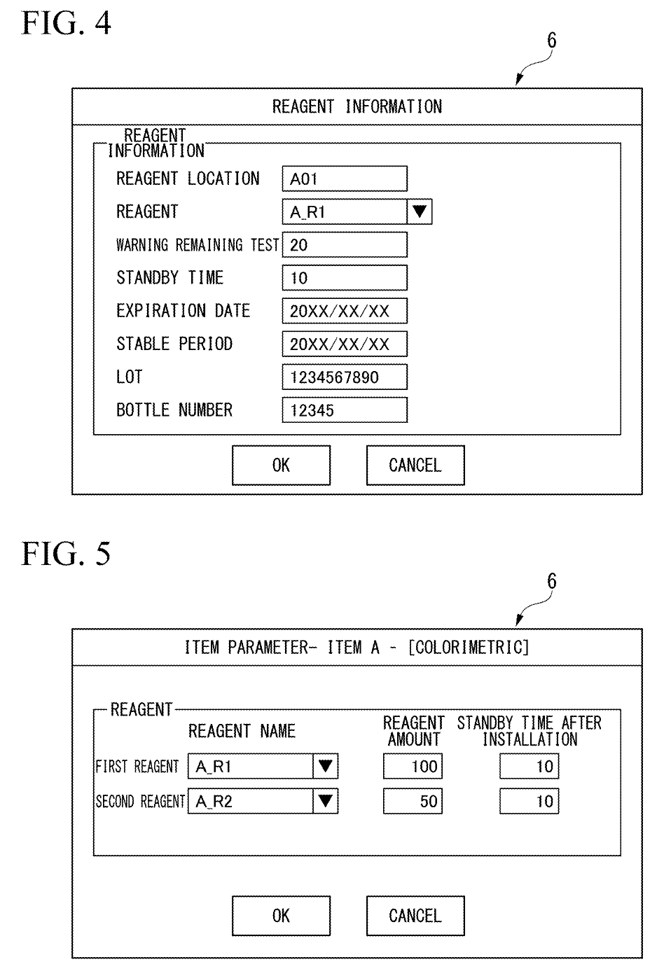

FIG. 4 shows an example of the display 6 on which reagent information is displayed. The reagent information displayed on the display 6 includes information such as “Reagent Location,” “Reagent,” “Warning Remaining Test,” “Standby Time,” “Expiration Date,” and “Stable Period.” The reagent information also includes bottle information such as “Lot” and “Bottle Number.”

FIG. 4 shows an example in which a 10-minute standby time is set as reagent information. In a case in which no standby time is set, the “Standby Time” item displays a “0” or “-” to indicate that no standby time is set. The user can change the content of each item of reagent information by operating the input interface 5 while viewing the reagent information displayed on the display 6. The “Standby Time” displayed on the display 6 is, for example, a reference standby time displayed under the control of the display control function 95, and is a time that can be changed using the reception function 93 or the adjustment function 94.

The user can set a standby time, cancel the setting, or change the set time, for example, by operating the input interface 5. When the user sets or adjusts a reagent time, the input interface 5 outputs designation information corresponding to the input operation of the user to the control circuitry 9.

Next, the adjustment function 94 determines whether to adjust the standby time on the basis of the cooling status information (step S109). The adjustment function 94 acquires, for example, information on whether the reagent bottle 224 has been stored in a refrigerator or at room temperature as the cooling status information. For example, in a case in which the reagent bottle 224 has been stored in a refrigerator, the adjustment function 94 determines not to adjust the standby time, and in a case in which the reagent bottle 224 has been stored at room temperature, the adjustment function 94 determines to extend the standby time by a certain time. The adjustment function 94 may change and set the duration of the standby time on the basis of the cooling status information. If the adjustment function 94 determines that the standby time should be adjusted, the adjustment function 94 adjusts and changes the standby time (step S111).

If the adjustment function 94 determines not to adjust the standby time, the reception function 93 then determines whether designation information transmitted via the input interface 5 has been received (step S113). If the reception function 93 determines that the designation information has been received, the reception function 93 sets a standby time on the basis of the received designation information (step S111). If the reception function 93 determines that the designation information has not been received, the processing of step S111 is skipped.

Next, the system control function 91 transports the reagent bottle 224 inserted into the reagent loading section 118 to the reagent storage 102 and installs the same therein by controlling the automatic reagent loading mechanism 125 and the reagent bottle transport mechanism (step S115). Next, the system control function 91 determines whether the set standby time has elapsed since the reagent bottle 224 has been installed in the reagent storage 102 (step S117).

If the system control function 91 determines that the standby time has not elapsed, the system control function 91 repeats the processing of step S117 and causes the pipetting mechanisms 160, 170, and 180 to wait for dispensing. If the system control function 91 determines that the standby time has elapsed, the system control function 91 enables the pipetting mechanisms 160, 170, and 180 to begin dispensing (step S119). The automatic analysis apparatus 1 then ends the processing shown in FIG. 3.

In the embodiment, the automatic analysis apparatus 1 causes the pipetting mechanisms 160, 170, and 180 to wait for dispensing until the standby time elapses from when the automatic reagent loading mechanism 125 transfers the reagent bottle 224 to the reagent storage 102. Therefore, when dispensing by the pipetting mechanisms 160, 170, and 180 begins, the reagent contained in the reagent storage 102 is cooled and adjusted to a temperature suitable for testing. This prevents a decrease in analytical accuracy.

Furthermore, in the automatic analysis apparatus 1, after the reagent bottle 224 is transferred to the reagent storage 102, liquid surface shaking or foaming of the reagent may occur. In response to this, the automatic analysis apparatus 1 of the embodiment causes the pipetting mechanisms 160, 170, and 180 to wait for dispensing until the standby time elapses from when the reagent bottle 224 is transferred to the reagent storage 102. Accordingly, it is possible to secure a time for liquid surface shaking or foaming to subside, thereby more effectively preventing a decrease in analytical accuracy.

The display control function 95 may also display reagent information on the display 6 in other formats. FIGS. 5 to 7 show other examples of the display 6 on which reagent information is displayed. For example, as shown in FIG. 5, for each test item, a standby time may be displayed along with the name and amount of each of first and second reagents.

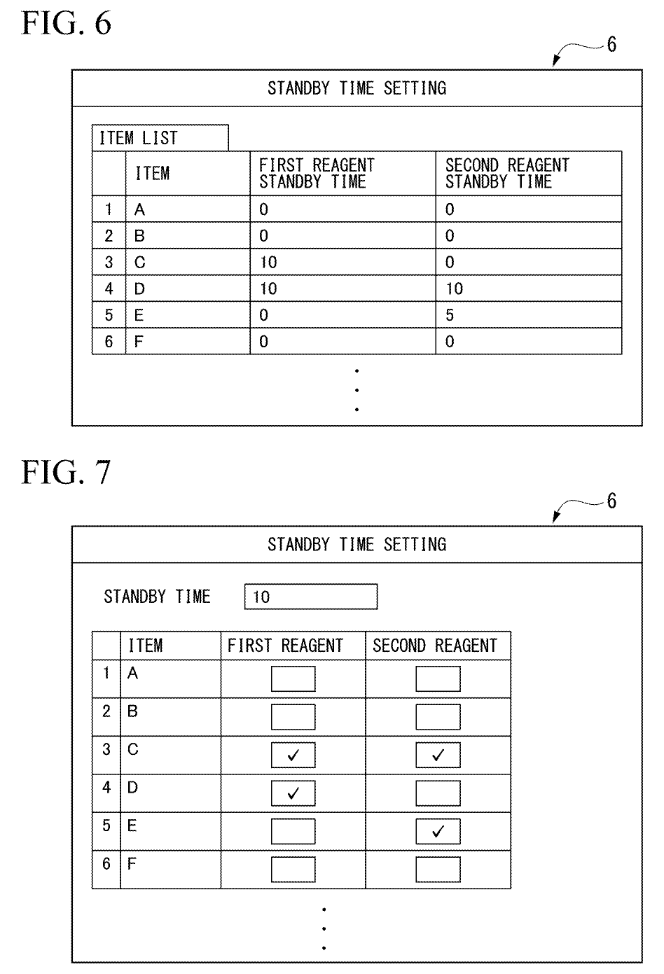

Furthermore, as shown in FIG. 6, an item list listing a plurality of test items may be generated, and standby times for the first and second reagents may be displayed for each test item. Furthermore, as shown in FIG. 7, a fixed standby time may be set and a screen for selecting a test item for which the fixed standby time is to be applied to the first or second reagent may be displayed.

According to at least one of the embodiments described above, the automatic analysis apparatus includes a reagent storage for storing a plurality of reagent bottles, an automatic reagent loading mechanism for transporting the reagent bottles from a reagent loading section to the reagent storage, a dispensing mechanism for dispensing reagents contained in the reagent bottles stored in the reagent storage, and a control unit for causing the dispensing mechanism to wait for dispensing until a standby time elapses from a reference time corresponding to when the reagent bottles are transported to the reagent storage and installed in the reagent storage by the automatic reagent loading mechanism, thereby preventing decrease in analytical accuracy.

The automatic analysis apparatus may be any medical analysis apparatus that analyzes a sample to be analyzed (test sample), such as a specimen collected from a subject (e.g., a human or animal), by mixing the sample with reagents contained in reagent bottles. Therefore, the automatic analysis apparatus is not limited by any particular analytical method, and includes, for example, biochemical analysis apparatuses, blood coagulation analysis apparatuses, immunoassay analysis apparatuses, and various chromatographic analysis apparatuses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An automatic analysis apparatus comprising:
a reagent storage storing a plurality of reagent bottles;
an automatic reagent loading mechanism configured to transport the reagent bottles from a reagent loading section to the reagent storage;
a dispensing mechanism configured to dispense reagents contained in the reagent bottles stored in the reagent storage; and
processing circuitry configured to cause the dispensing mechanism to wait for dispensing until a standby time elapses from a reference time corresponding to when the reagent bottles are transported to the reagent storage and installed in the reagent storage by the automatic reagent loading mechanism.

2. The automatic analysis apparatus according to claim 1, wherein the standby time is set based on types of the reagents.

3. The automatic analysis apparatus according to claim 1, wherein the standby time is set based on test items set for samples to be tested using the reagents.

4. The automatic analysis apparatus according to claim 1, comprising a memory storing the standby time,
wherein the processing circuitry acquires the standby time stored in the memory.

5. The automatic analysis apparatus according to claim 4, wherein the processing circuitry causes a display to display the standby time.

6. The automatic analysis apparatus according to claim 5, wherein the processing circuitry causes the display to display the standby time for each reagent.

7. The automatic analysis apparatus according to claim 5, wherein the processing circuitry causes the display to display the standby time for each test item.

8. The automatic analysis apparatus according to claim 4, wherein the processing circuitry adjusts the standby time based on a cooling status of the reagent bottles.

9. The automatic analysis apparatus according to claim 1, comprising an input interface through which a user inputs the standby time,
wherein the processing circuitry receives input of the standby time.

10. The automatic analysis apparatus according to claim 9, wherein the processing circuitry causes the display to display a reference standby time, which is a standard for the standby.

11. An automatic analysis method in an automatic analysis apparatus comprising a reagent storage storing a plurality of reagent bottles, an automatic reagent loading mechanism configured to transport the reagent bottles from a reagent loading section to the reagent storage, and a dispensing mechanism configured to dispense reagents contained in the reagent bottles stored in the reagent storage,
the automatic analysis method comprising causing the dispensing mechanism to wait for dispensing until a standby time elapses from a reference time corresponding to when the reagent bottles are transported to the reagent storage and installed in the reagent storage by the automatic reagent loading mechanism.
